(19) United States
(12) Patent Application Publication
(10) Pub. No.: US 2026/0065226 A1
(43) Pub. Date: Mar. 5, 2026

(54) AI-ASSISTED PROJECT SUMMARY AND REPORT GENERATION

(71) Applicant: Oracle International Corporation, Redwood Shores, CA (US)

(72) Inventors: Pyay Aung San, Redwood Shores, CA (US); Yogendra Swami, Telangana (IN); Jeffrey Thomas Colvard, Redwood Shores, CA (US); Sai Teja Repalle, Telangana (IN); George M. Cherian, Kerala (IN); Simon Ball, San Francisco, CA (US); Forrest Elliott, Seattle, WA (US); Alexander Lederman, Redwood Shores, CA (US); Peter Weiss, Golden, CO (US)

(73) Assignee: Oracle International Corporation, Redwood Shores, CA (US)

(21) Appl. No.: 19/170,279

(22) Filed: Apr. 4, 2025

Related U.S. Application Data
(60) Provisional application No. 63/690,744, filed on Sep. 4, 2024.

(51) Int. Cl. G06Q 10/10; G06N 20/00

(52) U.S. Cl. CPC G06Q 10/103; G06N 20/00

(57) ABSTRACT

Systems, methods, and computer-readable media are provided for generating natural language project summaries via large language models including deterministically derived data value narratives. A computer-implemented method includes processing a first input configuring data stored in association with a plurality of fields, generating a narrative for a project, and causing display of the narrative in a report for the project. The narrative is generated by applying one or more deterministic operations to derive one or more values for the project based at least in part on at least one field of the plurality of fields, based at least in part on the configured data, generating a prompt, prompting a large language model with the prompt to generate a result, and storing the result as the narrative for the project. The prompt includes the one or more derived values and a context comprising the project for which a narrative is being generated.

### CROSS-REFERENCE TO RELATED APPLICATIONS

This application claims the benefit U.S. Provisional Patent Application No. 63/690,744 filed Sep. 4, 2024. The entire disclosure of the aforementioned application is incorporated by reference herein in its entirety for all purposes.

### BACKGROUND

Project management includes a great deal of complexity in expansive projects entailing multiple tasks, sub-projects, and obtained data about the project. Communicating the details of the project at various stages to the potentially large number of interested parties is a difficult task, requiring knowledge of different parts of a project and the most important data to provide within a communication. When creating summaries of a project, it is common to omit key details which may go undetected. Communications about a project that are created on a regular basis also may not capture important insights about the project at a time when it is most important. Missed insights and inaccurate project decisions can be incredibly costly.

### BRIEF SUMMARY

In some embodiments, systems, methods, and computer-readable media are provided for generating natural language project summaries via large language models including deterministically derived data value narratives. A computer-implemented method includes processing a first input configuring data stored in association with a plurality of fields, generating a narrative for a project, and causing display of the narrative in a report for the project. The narrative is generated by applying one or more deterministic operations to derive one or more values for the project based at least in part on at least one field of the plurality of fields, based at least in part on the configured data, generating a prompt, prompting a large language model with the prompt to generate a result, and storing the result as the narrative for the project. The prompt includes the one or more derived values and a context comprising the project for which a narrative is being generated.

In a particular embodiment, a computer-implemented method includes processing a first input configuring data stored in association with a plurality of fields. The configured data indicating a first set of one or more fields of the plurality of fields is in use and a second set of one or more fields is not in use. The computer-implemented method further includes generating a narrative for a project and causing display of the narrative in a report for the project. The narrative for the project is generated at least in part by applying one or more deterministic operations to derive one or more values for the project based at least in part on at least one field of the first set of one or more fields. The computer-implemented method further includes, based at least in part on the configured data, generating a prompt, prompting a large language model with the prompt to generate a result, and storing the result as the narrative for the project. The prompt includes at least the one or more derived values while excluding one or more other values for the second set of one or more fields or one or more other values derived from the second set of one or more fields, and a context including the project for which a narrative is being generated, the project being one of a plurality of projects for which prompts can be generated.

In a further embodiment, the computer-implemented method further includes determining one or more narratives based at least in part on the at least one field of the first set of one or more fields and editing the one or more narratives to include the one or more derived values. The prompt also includes the one or more narratives.

In the same or a different further embodiment, the applying one or more deterministic operations further includes determining the one or more values to be beyond a threshold value and selecting additional information for inclusion in the prompt based at least in part on the one or more values being beyond the threshold value.

In another embodiment that extends the particular embodiment or any further embodiment, the prompt specifies a role to assume when answering the prompt. Generating the prompt includes identifying the role based on a u ser account for which the summary narrative is being generated.

In another embodiment that extends the particular embodiment or any further embodiment, the prompt specifies a program name and a program definition for a program being summarized by an answer to the prompt. Generating the prompt includes identifying the program name and the program definition based at least in part on data stored in association with the program, and inserting the program name and the program definition into the prompt.

In another embodiment that extends the particular embodiment or any further embodiment, the applying one or more deterministic operations is performed by a first artificial intelligence agent, and the generating a prompt is performed by a second artificial intelligence agent. The first artificial intelligence agent has access to one or more tools using one or more APIs, and access to the one or more tools is managed using one or more authentication keys that are inaccessible to the second artificial intelligence agent.

In another embodiment that extends the particular embodiment or any further embodiment, the applying one or more deterministic operations to derive one or more values for the project is also based at least in part on a natural language input received from a user. The computer-implemented method further includes analyzing the natural language input by an artificial intelligence agent to determine at least one other field of the first set of one or more fields.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for generating project summaries.

FIG. 2 illustrates a system diagram showing an example cloud infrastructure for generating project summaries.

FIG. 3 illustrates an example user interface of a project management system.

FIG. 4 illustrates a user interface for generating project summaries.

FIG. 5 illustrates a user interface displaying a generated project summary.

FIG. 6A-C illustrate user interfaces for further modifying generated project summaries.

FIG. 7A-B illustrates the results of further modifications to generated project summaries.

FIG. 8 illustrates a user interface for selecting data fields for inclusion in project summaries.

FIG. 9A-9B illustrates a user interface for selecting values for data fields for inclusion in project summaries.

FIG. 10 depicts a simplified diagram of a distributed system for implementing certain aspects.

FIG. 11 is a simplified block diagram of one or more components of a system environment by which services provided by one or more components of an embodiment system may be offered as cloud services, in accordance with certain aspects.

FIG. 12 illustrates an example computer system that may be used to implement certain aspects.

### DETAILED DESCRIPTION

A description is provided for generating natural language project summaries via large language models including deterministically derived data value narratives. In various embodiments, the generation of project summaries is implemented using non-transitory computer-readable storage media to store instructions which, when executed by one or more processors of a computer system, cause display of the user interface and processing of the received input to generate project summaries. The generation of project summaries may be implemented on a local or cloud-based computer system that includes processors and a display for showing the user interface to a user for generating project summaries. The computer system may communicate with client computer systems for generating project summaries.

A description of the generation of project summaries is provided in the following sections:
GENERAL OVERVIEW
PRE-PROCESSING DATA
PROMPT GENERATION
EXECUTION AGAINST LLM AND POST-PROCESSING
SUMMARY GENERATION BY AI AGENTS
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### General Overview

A project may describe any number of collected tasks, programs, orchestrations, compositions of tasks, plans, steps, etc. and/or the creative or constructive output of those by an organization. Projects may include, for example, programs, elements of programs, implementation of various organization strategies, creation and implementation of new products, or any collections of tasks for a targeted outcome for the organization. Projects are often complex, with multiple factors for consideration in organizing, each factor potentially generating data to be analyzed.

When organizing a project between different contributors, disseminating information to all contributors and other interested parties about the progress or other factors of a project is important for the success of the project. Creating a summary of information relating to the project is difficult as the data referenced may be from a multitude of sources and the different facets of the project may not all be understood by a user attempting to create the summary. For example, a project may also contain multiple sub-projects, each containing their own data and managed in a coordinated way to achieve strategic objectives. Summaries may be made of information for the project and each of its sub-projects. For all instances below, a process performed for a “project” may be performed for a project containing multiple sub-projects or performed for a sub-project.

A summary may comprise natural language text data containing information about a project in a human readable format. The information about a project contained within a summary may include, for example, a status condition of a project, current projected numerical metrics for the project, or recorded numerical metrics for the project collected to date.

A summary may be generated by a project management system by prompting a large language model to generate a natural language summary including the necessary data and metrics about the project that the user wishes to include in the summary. The summary may be altered by altering the prompt provided to the large language model, including the instructions within the prompt and the data provided for inclusion in the summary. The summary may also be further altered by the user by directly editing the summary generated by the large language model or by re-prompting the large language model to generate another prompt based on indicated differences to the original generated summary.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

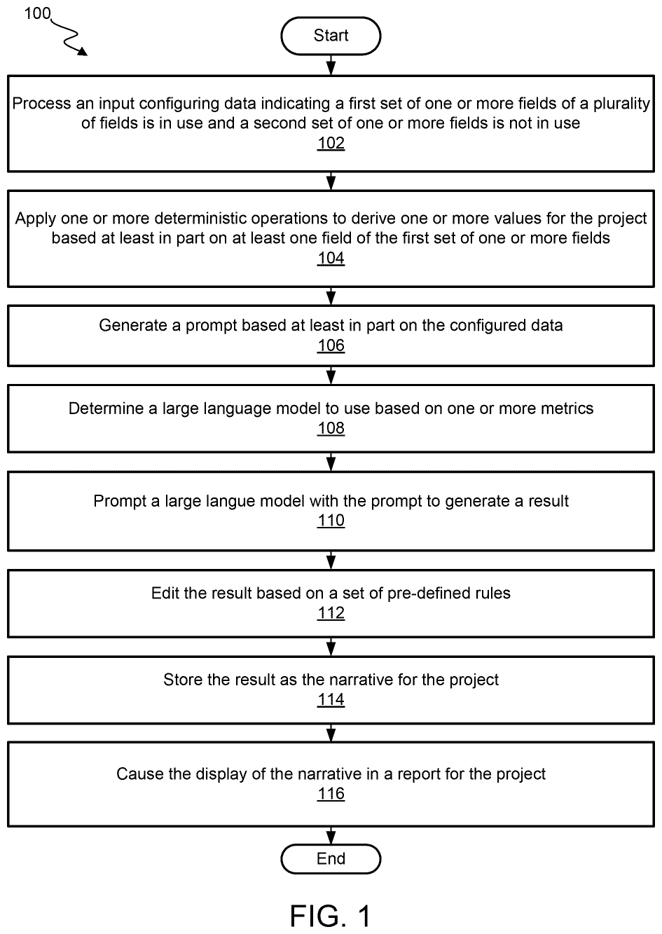

FIG. 1 depicts a flowchart 100 of a method for generating project summaries. At block 102, an input is processed that configures data stored in association with a plurality of fields, wherein the configured data indicates a first set of one or more fields of the plurality of fields is in use and a second set of one or more fields is not in use. At block 104, one or more deterministic operations are applied to derive one or more values for the project based at least in part on at least one field of the first set of one or more fields. At block 106, a prompt is generated based at least in part on the configured data. The prompt includes at least the one or more derived values, with the one or more other values for the second set of one or more fields or one or more other values derived from the second set of one or more fields are excluded. The prompt also includes a context including the project for which a narrative is being generated, where the project is one of a plurality of projects for which prompts can be generated. At block 108, a large language model to be the target of the prompt is determined based on one or more metrics. At block 110, the determined large language model is prompted with the prompt to generate a result. At block 112, the result may be edited based on a set of pre-defined rules. At block 114, the result is stored as the narrative for the project. At block 116, the system causes the display of the narrative in a report for the project.

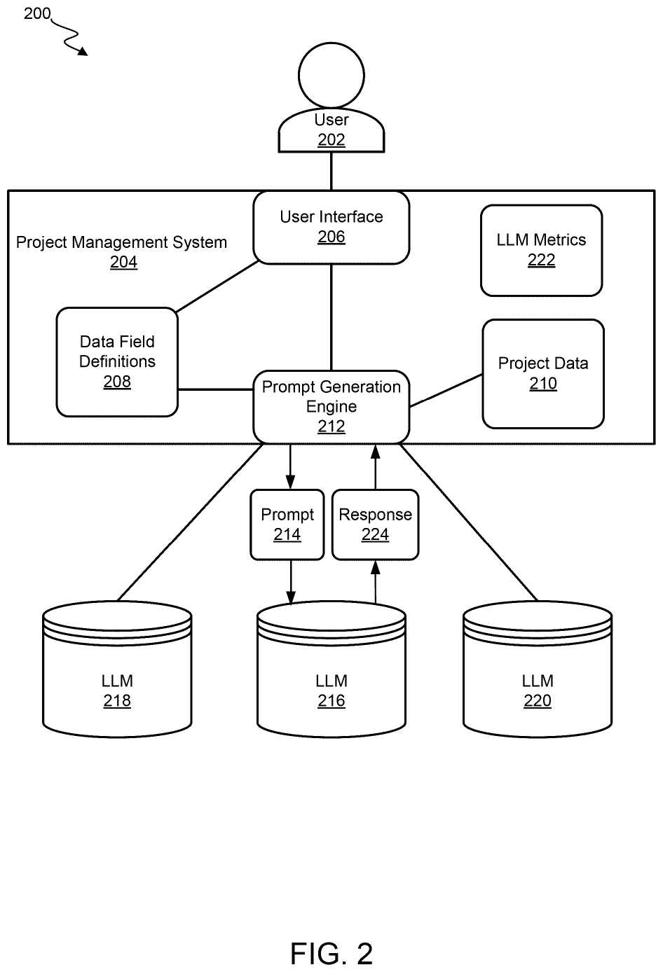

FIG. 2 depicts a system 200 for generating project summaries. A user 202 interacts with a project management system 204 via a user interface 206. Via the user interface 206, the user 202 can direct data fields to be enabled or disabled, which are stored with the data field definitions 208. The data field definitions contain logical expressions or transformations for interpreting project data 210 into a natural language format, which is fed to a prompt generation engine 212 for inclusion in a prompt. The prompt generation engine receives a request via the user interface 206 to generate a project summary, and the prompt generation engine 212 generates a prompt 214. The prompt generation engine may also include one or more artificial intelligence agents. The prompt 214 is prompted against a large language model 216 of a plurality of large language models 216-220. The large language model 216 is selected from the plurality of large language models 216-220 based on at least one metric from a set of LLM metrics 222. The large language model 216 generates a response 224 to the prompt 214 which is received by the project management system 204 and displayed via the user interface 206.

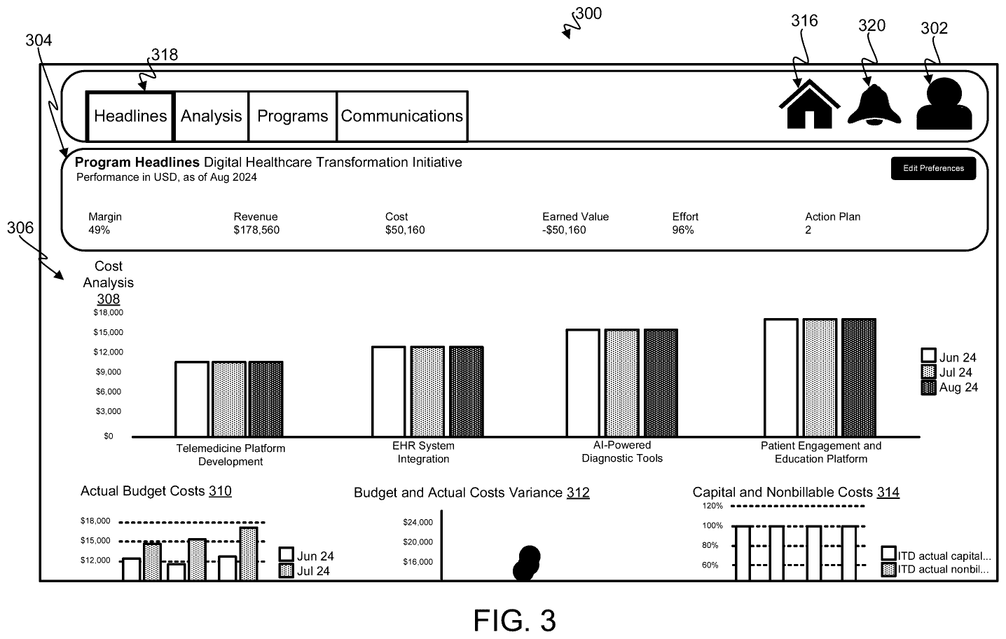

FIG. 3 depicts an example user interface 300 detailing project data. The interface may be accessed by a user 302, such as via user credentials specific to the user 302. The user 302 may, via their user credentials, have access to the project 304. The project 304 may The user interface 300 may also display project information 306 about the project 304. The project information 306 may be displayed in one or more data visualizations 308-314. The user interface 300 may also contain one or more navigation tools 316-318, which may include a page navigation tool 318 for navigating between different pages of the user interface 300 and may include a default view tool 316 for displaying a default view for the user 302. The user interface may also include a communications tool 320 for displaying communications such as notifications of new summaries for the project 304.

### Pre-Processing Data

Prior to generation of the prompt, any number of pre-processing steps may be performed for accumulating, formatting, or labeling of data to be used in the generation of the project summary. Pre-processing of data may be determined by a set of user-defined settings for the generation of project summaries, such as the determination of data fields to include in the project summary.

Prior to generation of the prompt, the project management system may check for a set of user credentials associated with the user requesting the project summary. The project management system may determine, based on the user credentials, whether access is permitted to the data for the project summary. The user credentials may determine a user's eligibility to the entire project, to specific sets of data of the project, or whether the user has permissions for generating project summaries. Based on the user credentials, the fields of data available may be restricted and the restrictions on the data may be displayed to the user via the user interface.

Specific fields of data may be transformed via pre-determined heuristics and other deterministic operations. For example, fields of information that require lookup of project-specific data and locating that data in the proper place in a sentence may be handled in-advance via pre-determined heuristics that automatically import the required data into pre-defined natural language. The pre-determined heuristics may be stored in a table such that for each project, the corresponding fields with pre-determined heuristics may be determined and stored in advance. For all fields transformed by pre-determined heuristics, the output transformed value for the field may be stored to be incorporated into the prompt

The pre-determined heuristics may be performed by a set of defined operations with custom logic for each field. For example, a specific field may indicate project costs. A set of logical operations may be defined for the project costs field that lookup known sources of costs for the project. The known sources of costs may be defined in the pre-defined operations, such as a default set of costs, which are calculated based on a pre-defined formula. Alternatively, the known sources of costs may be defined in the project data so as to define the relevant project costs specific to the project in question. The sources of costs defined in project data may be stored as meta-data on the sources of cost data, such as a flag, indicating that the value is a cost data.

The pre-determined heuristics may alternatively be implemented as a set of template language incorporating logical operations to complete the template language. For example, for a project costs field, a template language may state “Program Cost Performance Index is {program_cost_performance_index}. Program Schedule Performance Index is {program_schedule_performance_index}” where {program_cost_performance_index} and {program_schedule_performance_index} indicate the target location for a set of logical operations to determine a value based on the project data. In this case, the program_cost_performance_index value may be determined by a mathematical operation on a set of data values representing a predicted cost performance and a calculated actual cost performance that results in the program cost performance index value.

The pre-determined heuristics may also detect anomalies in the values they are to determine. For example, a template language may incorporate conditional language in the case that a value exceeds a given threshold. The threshold for any value may be determined in advance, or may be determined based on a logical expression, checked against stored historical data for the same value.

### Prompt Generation

In order to generate a project summary, a prompt is generated to prompt a large language model to generate an output summary. The prompt may include a set of instructions for the large language model to define the desired output, set constraints on the generation of that output, project data for including in the project summary, and descriptions of the project data included.

The prompt may be generated automatically when populating a user interface detailing the project or it may be generated in response to a received input by a user. The prompt may be presented to the user for confirmation or editing before passing the prompt to the large language model.

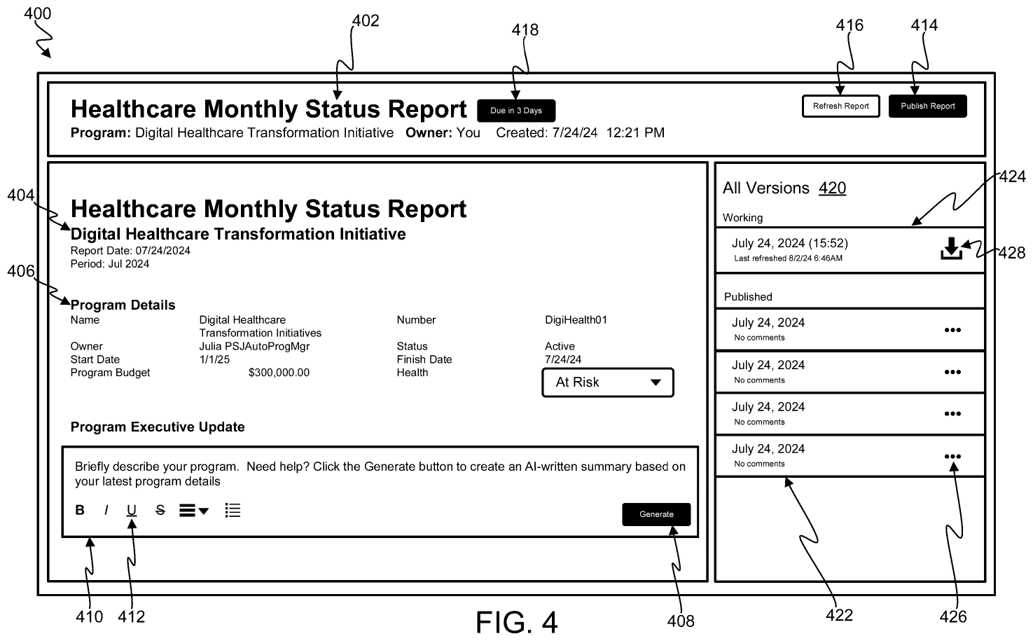

FIG. 4 depicts a user interface 400 for generating project summaries. The user interface 400 is configured for generating a project summary report 402 for the project 404. The user interface 400 also displays project details 406 of the project 404, which may include, for example, a name, owner, identification number, relevant dates, or financial information. The user interface contains a first option for user input 408 to generate the project summary within a project summary display region 410. When a user selects the first option 408 to generate the project summary, the project management system generates a prompt, executes the prompt against a large language model, and receives a generated output summary to display in the project summary display region 410. The user may also enter a project summary into the project summary display region 410 or may, after generating a summary by selecting the first option 408 to generate the project summary, edit the generated project summary. In editing the generated project summary, the user may use one or more text editing tools 412 of the project summary display region 410. The user interface also contains a second option for user input 414 to publish the project summary report 402 including the currently displayed project summary within the project summary display region 410. The user interface also contains a third option for user input 416 to refresh the user interface 400 and optionally remove any edits by the user to the project summary displayed in the project summary display region 410. The third option for user input 416 may also cause the project summary display region 410 to display an updated project summary after new project information or edits to the project summary are received from another user. The user interface 400 also contains project summary report publication information 418 detailing information about the publishing of the project summary report 402 such as a due date of the project summary report. The user interface 400 also displays a version control region 420 containing controls for displaying different versions of the project summary report 402. The version control region 420 may include one or more past versions 422 and one or more current versions 424. The one or more past versions or current versions 422-424 may be selected to update the user interface 400 to display the selected version of the project summary report 402. The version control region 420 also includes version control selections 426 for selecting one or more actions to perform with the selected version such as a download selection 428.

The prompt may include a set of instructions for generating the project summary. The instructions may direct the large language model as to the expected output, for example: “summarize the current status and key details for the project.” The instructions may also indicate a context for the project summary, such as an email format, press release, or website description.

The set of instructions in the prompt may further include constraints on the generation of the summary. For example, the prompt may include a word count constraint, a constraint on the type of language to use in the summary, or constrain the response to a number of paragraphs. The set of instructions may also include constraints to conform the output of the large language model to an expected format for parsing or interpreting after generation such as an instruction to remove any introductory phrase responsive specifically to the request of the prompt.

The prompt may also include a number of fields of data to be included in the project summary. These fields may detail elements of the project in numerical or textual format. The fields may be any number of metrics available for the given project and may be defined specifically for the project or may be a generic set of fields for all projects. The fields used for the project summary may be determined by the user. For example, the user may select from a list of pre-determined fields a number of fields to include in the summary. The available fields may also be restricted based on user credentials restricting access to certain fields of data. The fields selected may be determined automatically from the list of pre-determined fields from a context of the user's request, such as a user interface context or based on a user profile.

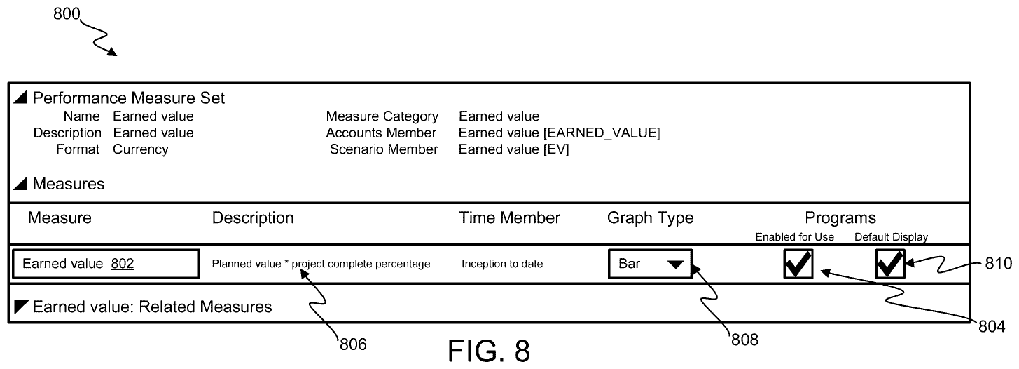

FIG. 8 depicts a user interface 800 for selecting fields to include in a project summary. The user interface 800 displays a data field 802 with an option for user input 804 to enable the use of the data field 802 in generating output summaries. The data field 802 is displayed with a description 806 describing additional details about the data field 802. The data field 802 is also displayed with a selection for a visualization setting 808 for a user to select a type of visualization that the data field 802 may be represented by such as a graph type. For example, a data field may represent components of a whole value, which may be selected to be displayed in a pie chart visualization. The data field 802 is also displayed with a selection for display 810 for selecting whether the visualization setting 808 is used for displaying a visualization for the data field 802 in a generated report.

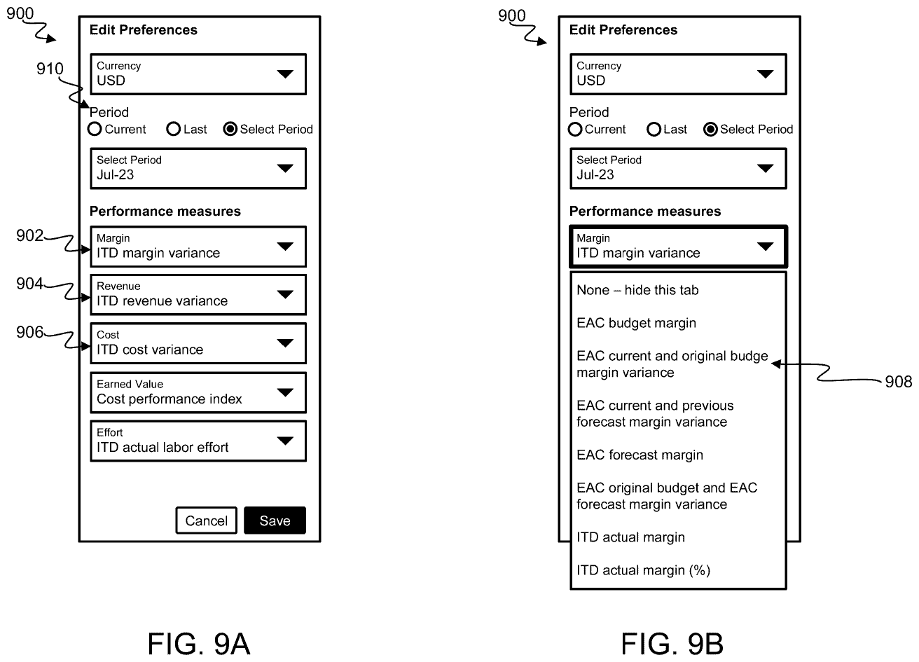

FIGS. 9A and 9B depict a user interface 900 for selecting settings relating to fields used in generating output summaries. The user interface 900 includes a plurality of selections for given fields 902-906 for selecting a value to use for each given field. The plurality of selection for given fields 902-906 may each be displayed, when selected, with an option for user input 908 to direct a value to use for the selected field 902 when generating an output summary using the selected field 902. Such a selection may, for example, select an alternate template for use in transforming the field into a natural language format. The user interface also includes a time series selection 910 for selecting a time series or a single time domain from which the data for the plurality of selections for given fields 902-906 is retrieved.

The prompt may also include instructions to guide the style of the generated summary. For example, the prompt may include a target audience or style of writing such as a professional style.

### Example Prompt:

### ###References

Program Definition: Program objective is customer service excellence for complex customer engagements. Program description is Application implementations for North America. Program region is North America. Program line of business is Service. Program strategy is Customer Service Excellence. Program has consumed 35% of total budget ($10,795,000). Program consists of 5 projects, out of which 2 are closed.
Margin Summary: In terms of margin, program is ahead compared to the plan by $16,000 with 17% actual margin percentage
Revenue Summary: In terms of revenue, program is ahead compared to the plan by $ 334,422 with $11,681,151 actual revenue.

### Cost Summary: Program Cost Performance Index is 0.95. Program Schedule Performance Index is 0.83.

Effort Summary: Actual labor effort that is not eligible for billing is 2.38% of total effort.
Action Plan Summary: {‘Action Plan Summary’: ‘Plan to recover from supplier delay’. ‘Deadline’: ‘28^{th} February 2023’, ‘Status’: ‘In progress’, ‘Action Plan Items’: ‘Adjust the schedule for supplier delays, Talk to controller’, ‘Overdue Action Items’: 1}

### ###Context

Assume the role of a program manager, distinguished for producing executive summaries that distill complex program data into insightful narratives. Your current assignment involves the {program_name} program, drawing on the provided references. Your objective is to highlight key trends and patterns through a narrative that acquaints stakeholders with the program's current standing and future outlook, all while avoiding direct citations from the references.

### ###Summary Structure and Contents

Your executive summary must be a detailed and cohesive narrative meticulously structured into exactly three paragraphs. This format is non-negotiable:

Begin with an introduction that sets the stage, offering a comprehensive overview of the dataset to establish the context of the {program_name} program. This paragraph should encapsulate the program's overarching goals and significance, laying a foundational backdrop for the analysis.

Transition to an in-depth exploration of the current state of the program in the second paragraph. This part should rigorously address projects needing immediate attention and provide an analysis of the program's financial and operational health, crafting a narrative that vividly illustrates current challenges and achievements.

Conclude with a decisive paragraph outlining the way forward. Leverage the insights gained from the previous analysis to suggest strategic actions or considerations, aiming to offer a clear, actionable direction for addressing the program's challenges and capitalizing on opportunities.

Aim for a narrative that is comprehensive, stretching close to {summary_lenght} words to ensure that you're not only adhering to the three-paragraph mandate but also producing a response that is rich in detail and analysis. This approach is critical for offering a deep, informative, and engaging overview of the program.

### ###Acceptance Criteria

The executive summary should strictly follow the three-paragraph structure, with an overall aim of nearing {summary_length} words to provide a depth of insight and analysis that meets professional standards. Employ straightforward, professional language, maintain a third-person perspective, and keep the tone neutral. The summary should be direct, informative, and compelling, crafted without formal closures or signatures and avoiding direct quotations or data enumeration.

### ###Formatting

The narrative should unfold seamlessly, integrating insights directly without explicit section headers or introductory phrases that fragment the content. Avoid any form of listing, such as bullet points or numbered items, to ensure a natural, fluid delivery that embeds the data into the narrative without partitioning the content artificially.

Remove any sentences that include the phrases: “the summary”, “this summary”, “the executive summary”, “this executive summary”, “the first section”, “the first paragraph”, “the second paragraph”, etc.

The “###References” section of the example prompt above details the various determined fields with pre-determined transformations based on heuristics. The “###Context” section of the example prompt above details the instructions to the large language model for the intended output and directs the large language model to include the above details of the “###References” section. The “###Summary Structure and Contents”, “###Acceptance Criteria”, and “###Formatting” sections set further constraints on the generation of the output summary.

### Execution Against LLM and Post-Processing

After generation of the prompt, the prompt is executed against a large language model to generate an output summary. The prompt may be executed against the large language model in a session with the large language model. The session with the large language model may be persistent or may only be used for executing a single prompt.

The project management system may determine a large language model to use from a set of large language models. The determination of a large language model to use may be based at least in part on a set of LLM metrics stored in the project management system. The set of LLM metrics may be populated by analysis of prior responses to prompts to various large language models. For example, a set of metrics may determine a large language model's percentage chance of prior responses aligning to constraints included in their prompts such as word count, tone, or inclusion of certain expected words or phrases. The metrics of the set of LLM metrics may be based on analysis by a large language model or by other analysis. For example, another large language model may be prompted to determine the output summary's adherence to the requested style of language requested in the prompt. In another example, an algorithm for applying a Flesch-Kincaid readability test to determine a readability of the output summary based on the sentence length and average word length.

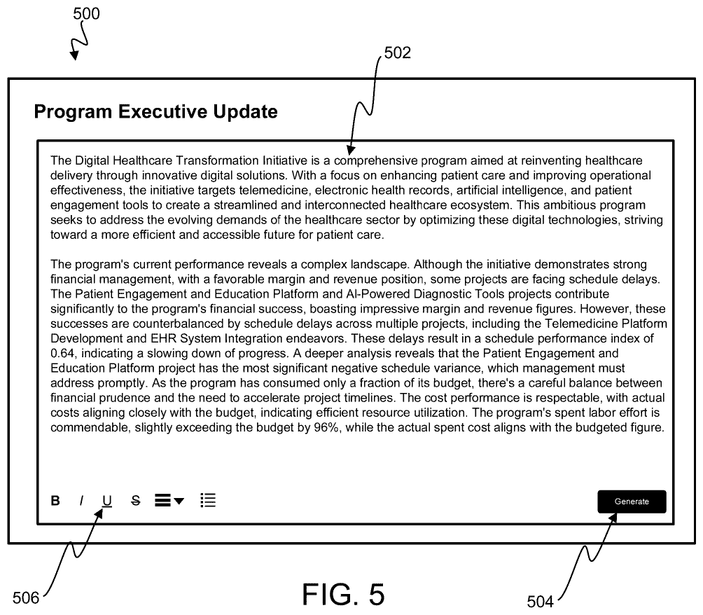

FIG. 5 depicts a user interface 500 for displaying a generated project summary. After a user input to generate a project summary, the system generates the project summary 502 which is displayed in the user interface 500. The user interface 500 also includes options to further edit the generated summary, such as the option for user input 504 to regenerate the project summary or by text editing tools 506.

The received output summary may be automatically parsed and edited based on default rules. For example, a pre-determined rule may direct the system to parse the output summary and remove pre-determined language, such as introductory language describing the summary generated. Another default rule may automatically parse the output summary for numerical values and a preceding keyword to compare with the associated value in the project data.

After receiving the output summary from the large language model, the output summary is displayed to the user. Within the display to the user, the output summary may be edited by the user to modify the output summary into a final project summary. Alternatively, the output summary may be modified by re-prompting the large language model to generate a second output summary with new criteria. In yet another alternative, the user interface may permit the entering of feedback from the user, which may be used in re-prompting the large language model.

When re-prompting the large language model, the previous prompt may be used in whole or in part to prompt the large language model to generate the second output summary. A second prompt may be used which may incorporate components of the previous prompt, such as the instructions or project data to include. The second prompt may also include the prior output summary with added instructions explaining the prior output summary to be a prior attempt to generate a summary by the large language model and any additional instructions of changes or differences to include in the second output summary. The second prompt may also include user feedback entered in response to the display of the prior output summary, which may indicate changes or differences to include in the second output summary.

Alternatively, when re-prompting the large language model, the second prompt may be sent to the large language model within the same session with the large language model as the previous prompt. In this case, the prompt may refer to the previous response and indicate changes or desired differences for a second output summary.

A user input indicating to re-prompt the large language model may be a selection from a pre-determined list of alterations to the output summary. For example, options may be displayed with the output summary to lengthen or shorten the output summary. In the case that a user selects an option to shorten or lengthen the output summary, a new prompt may be generated where the prompt is generated using a profile for generating shorter or longer prompts than a prior profile used to generate the first prompt.

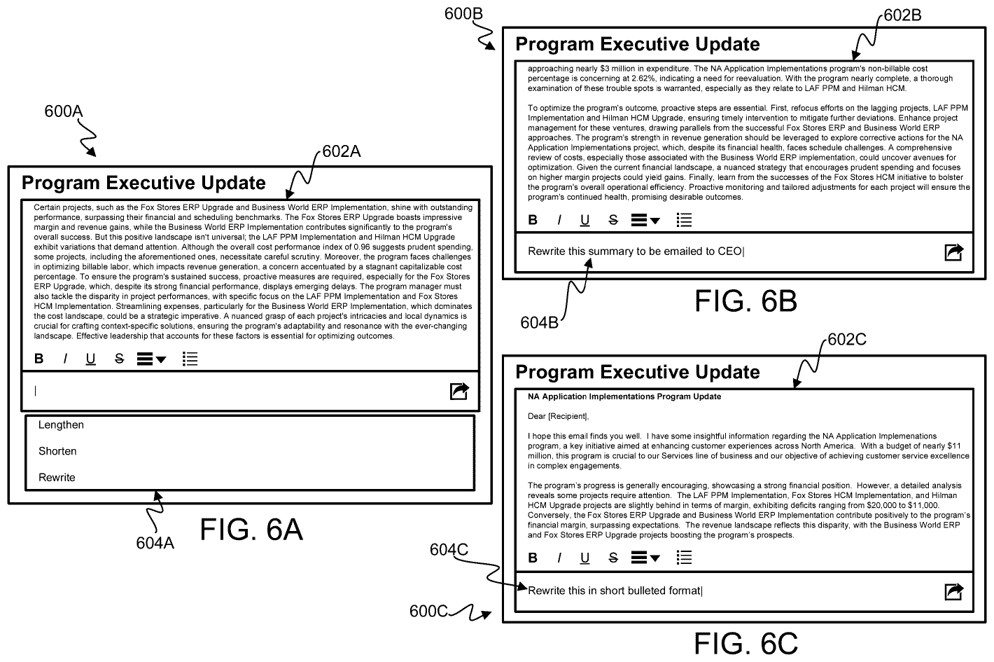

FIG. 6A-C depict various user interfaces for further refining generated project summaries. FIG. 6A depicts a user interface 600A displaying a first generated project summary 602A which may be re-prompted to generate a second generated project summary with selected re-prompt instructions 604A. The selected re-prompt instructions may be one of a set of pre-defined re-prompt instructions that correspond to a set of instructions or a template for re-prompting the large language model. FIG. 6B depicts a user interface 600B displaying a first generated project summary 602B which may be re-prompted to generate a second generated project summary with user-entered re-prompt instructions 604B. The user may enter the re-prompt instructions including a command, written in natural language, that is included in another prompt to the large language model or interpreted by the system to generate another prompt to the large language model. The user-entered re-prompt instructions 604B depict an instruction to rewrite the summary to a specific context. FIG. 6C depicts a user interface 600C displaying a first generated project summary 602C which may be re-prompted to generate a second generated project summary with user-entered re-prompt instructions 604C. The user-entered re-prompt instructions 604C depict an instruction to rewrite the summary in a specific format.

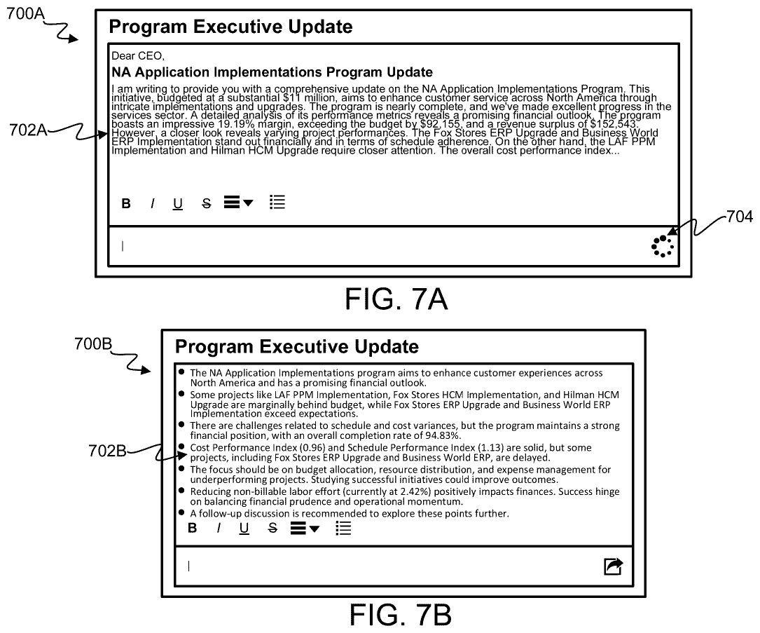

FIG. 7A depicts a user interface 700A displaying a second generated summary 702A resulting from the user-entered re-prompt instructions 604B of FIG. 6B. The second generated summary 702A has been rewritten to comply with the user entered re-prompt instructions 604B in the context of an email to a CEO. The second generated summary 702A is displayed in a partial format as it is generated. The user interface 700A may display a processing indicator 704 to indicate that the second generated summary 702A is still being generated. FIG. 7B depicts a user interface 700B displaying a second generated summary 702B resulting from the user-entered re-prompt instructions 604C of FIG. 6C. The second generated summary 702B has been rewritten to comply with the user entered re-prompt instructions 604C in a bulleted format.

After an output prompt is selected by the user and optionally undergone a post-processing step, the output summary may be stored and displayed to the user. The user interface for requesting a project summary may also include a publication method, such as sending the summary as a message or submitting the summary to public display on a website.

### Summary Generation by AI Agents

Various elements of the present disclosure for generating summaries of information relating to a project may be performed by an artificial intelligence agent. One or more artificial intelligence agents may be tasked with generating one or more summaries of information for one or more projects. The artificial intelligence agent may be trained to perform specific tasks with regards to project information such as generating the prompt to a large language model or performing tasks of interpreting data of the project information.

The one or more artificial intelligence agents may be specific to a certain type of information or use case. For example, an artificial intelligence agent may be trained only using information relating to sales data of one or more projects, in which case the artificial intelligence agent may be specific to the handling of generation of summaries of project information relating to sales data such as summaries of sales forecasting or profit realization. In another example, an artificial intelligence agent may be assigned to only perform operations relating to a certain set of parameters of data within project information and may be utilized only in the case where the certain set of parameters of data is present within the project information or has been determined to be required for generating the project summary.

An artificial intelligence agent may be specific to a certain role or task within the summary of project information such as generating summaries or analyzing project data. An artificial intelligence agent may analyze project data, for example, by taking as input a natural language input from a user including a request for including certain information in the summary and/or a type of summary to generate and may determine one or more fields of a set of data of the project information on which to perform one or more deterministic operations to derive one or more values for the project. An artificial intelligence agent may generate summaries for the project by taking as input one or more values or sets of data about the project and generating a prompt to a large language model to generate a summary of the project. The one or more artificial intelligence agents may be selected by first determining a type of information or use case of the project information. The determined type of information or use case may then be compared to a type of information or use case associated with each artificial intelligence agent of a plurality of pre-trained artificial intelligence agents. A project summary may be determined to include a plurality of types of data, such as a summary including financial information and personnel information, in which case the project summary may be generated using a plurality of artificial intelligence agents.

A project summary may be determined to have a specific context such as a use case of the project summary, which may be used to determine one or more artificial intelligence agents to use in generating the project summary. The project summary use case may be determined based on analysis of the project information, input by a user such as a natural language request indicating a use case of the project summary, or the project summary use case may be pre-determined such as in generating a regularly scheduled project summary for a certain use case such as a monthly summary. An artificial intelligence agent may be selected for use in generating the project summary based on the use case by determining a use case for the artificial intelligence agent. For example, a first artificial intelligence agent may be associated with a use case of public project summary reports and a second artificial intelligence agent may be associated with a use case of interpersonal communications including project summaries. For a regularly scheduled, public, monthly project summary, the first artificial intelligence agent may be selected to generate the summary based on the use case of the project summary being determined to be a public use case. For an email to a CEO including a project summary, the second artificial intelligence agent maybe be selected based on the use case of the project summary being determined to be an interpersonal communication. The artificial intelligence agents may have different tools or accesses to project information based on their use case. For example, the second artificial intelligence agent may have access to a set of private data that the first artificial intelligence agent does not have access to in order to prevent the set of private data being publicly disclosed and the first artificial intelligence agent may have access to an external news feed specific to the purpose of generating a public project summary.

In one embodiment, a managing agent determines one or more types of information being analyzed, and the managing agent assigns one or more worker agents specialized to handle each of the one or more types determined. The worker agents may analyze the information with the assistance of generative artificial intelligence, one or more customized prompt templates optionally specific to the corresponding worker agent, and/or one or more customized tools optionally specific to the to the corresponding worker agent. The managing agent may then assemble results from the one or more worker agents to provide a cohesive summary of the project information.

The one or more artificial intelligence agents may perform additional tasks prior to or after prompting a large language model for generating summaries of project information relevant to the type of information or use case associated with the information. For example, an artificial intelligence agent used for summarizing project information involving personally identifiable information may perform an extra step prior to generating a prompt of removing or masking certain personally identifiable information from the data such that the personally identifiable information is not exposed to the large language model. In another example, the same artificial intelligence agent may, after generating a prompt and prompting a large language model to generate a summary, perform an extra step of analyzing the generated summary and editing the summary or re-prompting the large language model to generate anew summary when aspects of the summary indicate a bias. The additional tasks may be facilitated by a set of tools accessible by the one or more artificial intelligence agents such as access to submit API calls, other machine learning models, templates, or access to further artificial intelligence agents.

Access to the set of tools by artificial intelligence agents may be managed by using one or more authentication keys. The one or more authentication keys may determine which artificial intelligence agents access which tools by controlling access to the authentication keys for each artificial intelligence agent. A first artificial intelligence agent may, for example, have access to an API as a tool via access to one or more authentication keys that are inaccessible to a second artificial intelligence agent. The authentication keys may be simple, static credentials issued to identify applications accessing a tool such as an API. The authentication key may be included in an access request to a tool such as in a request header or URL parameter to an API. An authentication key may also be a temporary access token granted after authentication such that access to the tool is time-limited. An authentication key may also be a credential of a set of credentials such as a username and password, such as for accessing a tool via a user's login, where the user is the current user requesting a summary to be generated by the artificial intelligence agent. Other means of authentication for artificial intelligence agent access to tools may include JSON Web Tokens, Mutual TLS, or Hash-managed Message Authentication Code.

The set of tools accessible by the one or more artificial intelligence agents may be specific to the artificial intelligence agent or the use case of the artificial intelligence agent, such as access to a personnel management toolkit accessible by an artificial intelligence agent for a human resources use case that is not accessible by artificial intelligence agents of other use cases so as to not expose personally identifiable information to other artificial intelligence agents. The set of tools accessible by the one or more artificial intelligence agents may also be a generic tool used to facilitate any artificial intelligence agent in the performance of tasks specific to their use case, such as a data search tool used by an artificial intelligence agent to determine the specific parameters or sets of data relevant to its use case.

In one example, the one or more artificial intelligence agents includes a managing artificial intelligence agent, which instantiates each of the one or more artificial intelligence agents used in generating project information summaries. The managing artificial intelligence agent may determine a number of other artificial intelligence agents necessary to generate summaries of project information for the project information in question, such as by parsing dimensions of data of the project information to determine a type of project information or use case. The managing artificial intelligence agent may determine, such as by parsing dimensions of data within the project information, a number of analyses to perform prior to generating a summary of the project information. For example, a managing artificial intelligence agent may determine that the project information contains data for sales of a first period, data for projected sales for the first period, and data for sales of a second period. The managing artificial intelligence agent may determine a first analysis to perform between the data for sales of the first period and data for projected sales for the first period and instantiate a first artificial intelligence agent for performing the first analysis and generating a first partial summary. The managing artificial intelligence agent may also determine a second analysis to perform between the data for sales of the first period and data for sales of the second period and instantiate a second artificial intelligence agent for performing the second analysis and generating a second partial summary. The managing artificial intelligence agent may receive the first and second partial summaries from the first and second artificial intelligence agents and may generate a cohesive summary based on the first and second partial summaries.

In another embodiment, an artificial intelligence agent may be tasked with determining when a feature of the project information should be included in a summary or should be used to generate a summary of the project information including the feature. For example, an artificial intelligence agent may be tasked with reviewing project information as the project information is updated and labeling features of the project information as relevant to a future summary to be generated or as a basis for generating a new summary. The artificial intelligence agent may perform data analysis on data of the project information and may store the results of the data analysis in association with the project information and a label for generating a future summary to include the results of the data analysis. In the case that the artificial intelligence agent detects a feature of the project information to include in a summary based on newly added project information, the artificial intelligence agent may generate a new version of an existing project summary by re-prompting the large language model with a prompt that includes at least the newly added project information. In the case that a new version of an existing project summary is generated by an artificial intelligence agent while an old version of the project summary is in use, the artificial intelligence agent may replace the old version with the new version of the project summary or send a request to a user interface indicating that a new version of the project summary is available.

The one or more artificial intelligence agents may communicate between each other by sharing information, derived analyses or generated summaries. For example, a first artificial intelligence agent may be tasked with performing data analysis on data of the project information, such as by applying one or more deterministic operations on a set of data of the project information, the results of which the first artificial intelligence agent gives to a second artificial intelligence agent for generating a summary including the results, such as by generating a prompt to a large language model. Artificial intelligence agents may share information including project information detected by the artificial intelligence agent to be important project information for a summary. For example, a number of artificial intelligence agents may generate summaries of information about individual projects and may send information about their individual projects to another artificial intelligence agent tasked with generating summaries including information about all of the individual projects in a single summary.

### Computer System Architecture

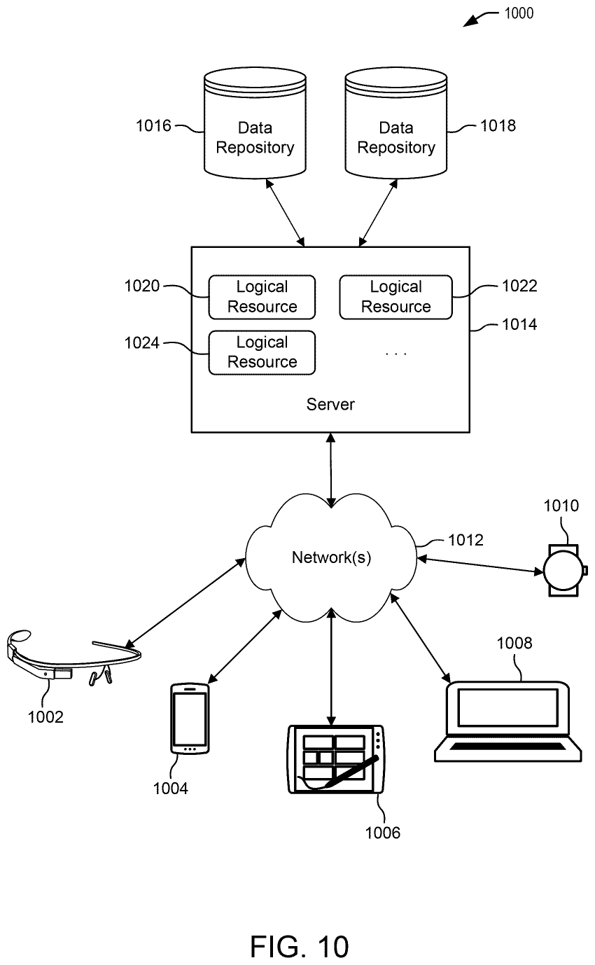

FIG. 10 depicts a simplified diagram of a distributed system 1000 for implementing an embodiment. In the illustrated embodiment, distributed system 1000 includes one or more client computing devices 1002, 1004, 1006, 1008, and/or 1010 coupled to a server 1014 via one or more communication networks 1012. Clients computing devices 1002, 1004, 1006, 1008, and/or 1010 may be configured to execute one or more applications.

In various aspects, server 1014 may be adapted to run one or more services or software applications that enable techniques for generating project summaries.

In certain aspects, server 1014 may also provide other services or software applications that can include non-virtual and virtual environments. In some aspects, these services may be offered as web-based or cloud services, such as under a Software as a Service (SaaS) model to the users of client computing devices 1002, 1004, 1006, 1008, and/or 1010. Users operating client computing devices 1002, 1004, 1006, 1008, and/or 1010 may in turn utilize one or more client applications to interact with server 1014 to utilize the services provided by these components.

In the configuration depicted in FIG. 10, server 1014 may include one or more components 1020, 1022 and 1024 that implement the functions performed by server 1014. These components may include software components that may be executed by one or more processors, hardware components, or combinations thereof. It should be appreciated that various different system configurations are possible, which may be different from distributed system 1000. The embodiment shown in FIG. 10 is thus one example of a distributed system for implementing an embodiment system and is not intended to be limiting.

Users may use client computing devices 1002, 1004, 1006, 1008, and/or 1010 for techniques for generating project summaries in accordance with the teachings of this disclosure. A client device may provide an interface that enables a user of the client device to interact with the client device. The client device may also output information to the user via this interface. Although FIG. 10 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1012 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1012 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth™, and/or any other wireless protocol), and/or any combination of these and/or other networks.

Server 1014 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 1014 can include one or more virtual machines running virtual operating systems, or other computing architectures involving virtualization such as one or more flexible pools of logical storage devices that can be virtualized to maintain virtual storage devices for the server. In various aspects, server 1014 may be adapted to run one or more services or software applications that provide the functionality described in the foregoing disclosure.

The computing systems in server 1014 may run one or more operating systems including any of those discussed above, as well as any commercially available server operating system. Server 1014 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1014 may include one or more applications to analyze and consolidate data feeds and/or event updates received from users of client computing devices 1002, 1004, 1006, 1008, and/or 1010. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1014 may also include one or more applications to display the data feeds and/or real-time events via one or more display devices of client computing devices 1002, 1004, 1006, 1008, and/or 1010.

Distributed system 1000 may also include one or more data repositories 1016, 1018. These data repositories may be used to store data and other information in certain aspects. For example, one or more of the data repositories 1016, 1018 may be used to store information for techniques for generating project summaries. Data repositories 1016, 1018 may reside in a variety of locations. For example, a data repository used by server 1014 may be local to server 1014 or may be remote from server 1014 and in communication with server 1014 via a network-based or dedicated connection. Data repositories 1016, 1018 may be of different types. In certain aspects, a data repository used by server 1014 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1016, 1018 may also be used by applications to store application data. The data repositories used by applications may be of different types such as, for example, a key-value store repository, an object store repository, or a general storage repository supported by a file system.

In one embodiment, server 1014 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

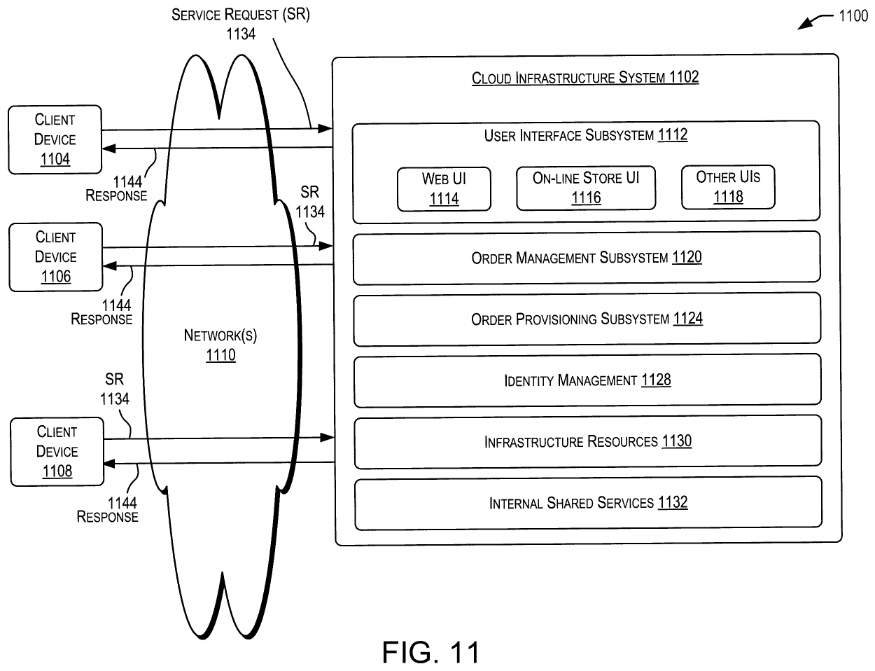

FIG. 11 is a simplified block diagram of a cloud-based system environment in which to generate project summaries, in accordance with certain aspects. In the embodiment depicted in FIG. 11, cloud infrastructure system 1102 may provide one or more cloud services that may be requested by users using one or more client computing devices 1104, 1106, and 1108. Cloud infrastructure system 1102 may comprise one or more computers and/or servers that may include those described above for server 1014. The computers in cloud infrastructure system 1102 may be organized as general purpose computers, specialized server computers, server farms, server clusters, or any other appropriate arrangement and/or combination.

Network(s) 1110 may facilitate communication and exchange of data between clients 1104, 1106, and 1108 and cloud infrastructure system 1102. Network(s) 1110 may include one or more networks. The networks may be of the same or different types. Network(s) 1110 may support one or more communication protocols, including wired and/or wireless protocols, for facilitating the communications.

The embodiment depicted in FIG. 11 is only one example of a cloud infrastructure system and is not intended to be limiting. It should be appreciated that, in some other aspects, cloud infrastructure system 1102 may have more or fewer components than those depicted in FIG. 11, may combine two or more components, or may have a different configuration or arrangement of components. For example, although FIG. 11 depicts three client computing devices, any number of client computing devices may be supported in alternative aspects.

The term cloud service is generally used to refer to a service that is made available to users on demand and via a communication network such as the Internet by systems (e.g., cloud infrastructure system 1102) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1110 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1102 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1102 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1102. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1102. Cloud infrastructure system 1102 then performs processing to provide the services requested in the tenant's subscription order. Cloud infrastructure system 1102 may be configured to provide one or even multiple cloud services.

Cloud infrastructure system 1102 may provide the cloud services via different deployment models. In a public cloud model, cloud infrastructure system 1102 may be owned by a third party cloud services provider and the cloud services are offered to any general public tenant, where the tenant can be an individual or an enterprise. In certain other aspects, under a private cloud model, cloud infrastructure system 1102 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1102 and the services provided may be shared by several organizations in a related community. Various other models such as hybrids of the above mentioned models may also be used.

Client computing devices 1104, 1106, and 1108 may be of different types (such as devices 1002, 1004, 1006, and 1008 depicted in FIG. 10) and may be capable of operating one or more client applications. A user may use a client device to interact with cloud infrastructure system 1102, such as to request a service provided by cloud infrastructure system 1102.

In some aspects, the processing performed by cloud infrastructure system 1102 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1102 for determining the intent of an utterance. The data used for this analysis may include structured data (e.g., data stored in a database or structured according to a structured model) and/or unstructured data (e.g., data blobs (binary large objects)).

As depicted in the embodiment in FIG. 11, cloud infrastructure system 1102 may include infrastructure resources 1130 that are utilized for facilitating the provision of various cloud services offered by cloud infrastructure system 1102. Infrastructure resources 1130 may include, for example, processing resources, storage or memory resources, networking resources, and the like.

In certain aspects, to facilitate efficient provisioning of these resources for supporting the various cloud services provided by cloud infrastructure system 1102 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1102 may itself internally use services 1132 that are shared by different components of cloud infrastructure system 1102 and which facilitate the provisioning of services by cloud infrastructure system 1102. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1102 may comprise multiple subsystems. These subsystems may be implemented in software, or hardware, or combinations thereof. As depicted in FIG. 11, the subsystems may include a user interface subsystem 1112 that enables users of cloud infrastructure system 1102 to interact with cloud infrastructure system 1102. User interface subsystem 1112 may include various different interfaces such as a web interface 1114, an online store interface 1116 where cloud services provided by cloud infrastructure system 1102 are advertised and are purchasable by a consumer, and other interfaces 1118. For example, a tenant may, using a client device, request (service request 1134) one or more services provided by cloud infrastructure system 1102 using one or more of interfaces 1114, 1116, and 1118. For example, a tenant may access the online store, browse cloud services offered by cloud infrastructure system 1102, and place a subscription order for one or more services offered by cloud infrastructure system 1102 that the tenant wishes to subscribe to. The service request may include information identifying the tenant and one or more services that the tenant desires to subscribe to. For example, a tenant may place a subscription order for a chatbot related service offered by cloud infrastructure system 1102. As part of the order, the client may provide information identifying the input (e.g. utterances).

In certain aspects, such as the embodiment depicted in FIG. 11, cloud infrastructure system 1102 may comprise an order management subsystem (OMS) 1120 that is configured to process the new order. As part of this processing, OMS 1120 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1120 may then invoke the order provisioning subsystem (OPS) 1124 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1124 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1102 may send a response or notification 1144 to the requesting tenant to indicate when the requested service is now ready for use. In some instances, information (e.g., a link) may be sent to the tenant that enables the tenant to start using and availing the benefits of the requested services.

Cloud infrastructure system 1102 may provide services to multiple tenants. For each tenant, cloud infrastructure system 1102 is responsible for managing information related to one or more subscription orders received from the tenant, maintaining tenant data related to the orders, and providing the requested services to the tenant or clients of the tenant. Cloud infrastructure system 1102 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1102 may provide services to multiple tenants in parallel. Cloud infrastructure system 1102 may store information for these tenants, including possibly proprietary information. In certain aspects, cloud infrastructure system 1102 comprises an identity management subsystem (IMS) 1128 that is configured to manage tenant's information and provide the separation of the managed information such that information related to one tenant is not accessible by another tenant. IMS 1128 may be configured to provide various security-related services such as identity services, such as information access management, authentication and authorization services, services for managing tenant identities and roles and related capabilities, and the like.

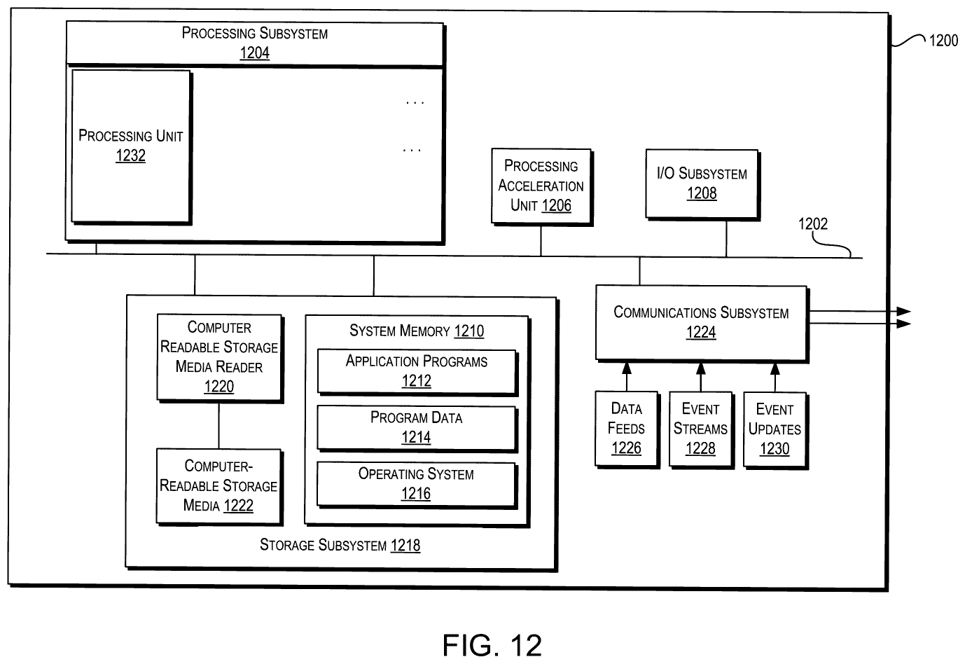

FIG. 12 illustrates an exemplary computer system 1200 that may be used to implement certain aspects. As shown in FIG. 12, computer system 1200 includes various subsystems including a processing subsystem 1204 that communicates with a number of other subsystems via a bus subsystem 1202. These other subsystems may include a processing acceleration unit 1206, an I/O subsystem 1208, a storage subsystem 1218, and a communications subsystem 1224. Storage subsystem 1218 may include non-transitory computer-readable storage media including storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative aspects of the bus subsystem may utilize multiple buses. Bus subsystem 1202 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1204 controls the operation of computer system 1200 and may comprise one or more processors, application specific integrated circuits (ASICs), or field programmable gate arrays (FPGAs). The processors may be single core or multicore processors. The processing resources of computer system 1200 can be organized into one or more processing units 1232, 1234, etc. A processing unit may include one or more processors, one or more cores from the same or different processors, a combination of cores and processors, or other combinations of cores and processors. In some aspects, processing subsystem 1204 can include one or more special purpose co-processors such as graphics processors, digital signal processors (DSPs), or the like. In some aspects, some or all of the processing units of processing subsystem 1204 can be implemented using customized circuits, such as application specific integrated circuits (ASICs), or field programmable gate arrays (FPGAs).

In some aspects, the processing units in processing subsystem 1204 can execute instructions stored in system memory 1210 or on computer readable storage media 1222. In various aspects, the processing units can execute a variety of programs or code instructions and can maintain multiple concurrently executing programs or processes. At any given time, some or all of the program code to be executed can be resident in system memory 1210 and/or on computer-readable storage media 1222 including potentially on one or more storage devices. Through suitable programming, processing subsystem 1204 can provide various functionalities described above. In instances where computer system 1200 is executing one or more virtual machines, one or more processing units may be allocated to each virtual machine.

In certain aspects, a processing acceleration unit 1206 may optionally be provided for performing customized processing or for off-loading some of the processing performed by processing subsystem 1204 so as to accelerate the overall processing performed by computer system 1200.

I/O subsystem 1208 may include devices and mechanisms for inputting information to computer system 1200 and/or for outputting information from or via computer system 1200. In general, use of the term input device is intended to include all possible types of devices and mechanisms for inputting information to computer system 1200. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1200 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1218 provides a repository or data store for storing information and data that is used by computer system 1200. Storage subsystem 1218 provides a tangible non-transitory computer-readable storage medium for storing the basic programming and data constructs that provide the functionality of some aspects. Storage subsystem 1218 may store software (e.g., programs, code modules, instructions) that when executed by processing subsystem 1204 provides the functionality described above. The software may be executed by one or more processing units of processing subsystem 1204. Storage subsystem 1218 may also provide a repository for storing data used in accordance with the teachings of this disclosure.

Storage subsystem 1218 may include one or more non-transitory memory devices, including volatile and non-volatile memory devices. As shown in FIG. 12, storage subsystem 1218 includes a system memory 1210 and a computer-readable storage media 1222. System memory 1210 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1200, such as during start-up, may typically be stored in the ROM. The RAM typically contains data and/or program modules that are presently being operated and executed by processing subsystem 1204. In some implementations, system memory 1210 may include multiple different types of memory, such as static random access memory (SRAM), dynamic random access memory (DRAM), and the like.

By way of example, and not limitation, as depicted in FIG. 12, system memory 1210 may load application programs 1212 that are being executed, which may include various applications such as Web browsers, mid-tier applications, relational database management systems (RDBMS), etc., program data 1214, and an operating system 1216. By way of example, operating system 1216 may include various versions of Microsoft Windows®, Apple Macintosh®, and/or Linux® operating systems, a variety of commercially-available UNIXR or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1222 may store programming and data constructs that provide the functionality of some aspects. Computer-readable media 1222 may provide storage of computer-readable instructions, data structures, program modules, and other data for computer system 1200. Software (programs, code modules, instructions) that, when executed by processing subsystem 1204 provides the functionality described above, may be stored in storage subsystem 1218. By way of example, computer-readable storage media 1222 may include non-volatile memory such as a hard disk drive, a magnetic disk drive, an optical disk drive such as a CD ROM, digital video disc (DVD), a Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1218 may also include a computer-readable storage media reader 1220 that can further be connected to computer-readable storage media 1222. Reader 1220 may receive and be configured to read data from a memory device such as a disk, a flash drive, etc.

In certain aspects, computer system 1200 may support virtualization technologies, including but not limited to virtualization of processing and memory resources. For example, computer system 1200 may provide support for executing one or more virtual machines. In certain aspects, computer system 1200 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1200. Accordingly, multiple operating systems may potentially be run concurrently by computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to establish a communication channel to one or more client devices via the Internet for receiving and sending information from and to the client devices. For example, the communications subsystem may be used to transmit a response to a user regarding the inquiry for a chatbot.

Communications subsystem 1224 may support both wired and/or wireless communication protocols. For example, in certain aspects, communications subsystem 1224 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1224 can provide wired network connectivity (e.g., Ethernet) in addition to or instead of a wireless interface.

Communications subsystem 1224 can receive and transmit data in various forms. For example, in some aspects, in addition to other forms, communications subsystem 1224 may receive input communications in the form of structured and/or unstructured data feeds 1226, event streams 1228, event updates 1230, and the like. For example, communications subsystem 1224 may be configured to receive (or send) data feeds 1226 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1224 may be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to communicate data from computer system 1200 to other computer systems or networks. The data may be communicated in various different forms such as structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1200 depicted in FIG. 12 is intended only as a specific example. Many other configurations having more or fewer components than the system depicted in FIG. 12 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
processing a first input configuring data stored in association with a plurality of fields, wherein the configured data indicates a first set of one or more fields of the plurality of fields is in use and a second set of one or more fields is not in use;
generating a narrative for a project at least in part by:
applying one or more deterministic operations to derive one or more values for the project based at least in part on at least one field of the first set of one or more fields;
based at least in part on the configured data, generating a prompt comprising:
at least the one or more derived values while excluding one or more other values for the second set of one or more fields or one or more other values derived from the second set of one or more fields, and
a context comprising the project for which a narrative is being generated, wherein the project is one of a plurality of projects for which prompts can be generated;
prompting a large language model with the prompt to generate a result; and
storing the result as the narrative for the project; and
causing display of the narrative in a report for the project.

2. The computer-implemented method of claim 1, wherein the method further comprises:
determining one or more narratives based at least in part on the at least one field of the first set of one or more fields; and
editing the one or more narratives to include the one or more derived values; and wherein the prompt also comprises the one or more narratives.

3. The computer-implemented method of claim 1, wherein the applying one or more deterministic operations further includes:
determining the one or more values to be beyond a threshold value; and
selecting additional information for inclusion in the prompt based at least in part on the one or more values being beyond the threshold value.

4. The computer-implemented method of claim 1, wherein the prompt specifies a role to assume when answering the prompt, wherein generating the prompt comprises identifying the role based on a u ser account for which the narrative is being generated.

5. The computer-implemented method of claim 1, wherein the prompt specifies a program name and a program definition for a program being summarized by an answer to the prompt, and wherein generating the prompt comprises identifying the program name and the program definition based at least in part on data stored in association with the program, and inserting the program name and the program definition into the prompt.

6. The computer-implemented method of claim 1, wherein the applying one or more deterministic operations is performed by a first artificial intelligence agent, wherein the generating a prompt is performed by a second artificial intelligence agent, wherein the first artificial intelligence agent has access to one or more tools using one or more APIs, and wherein access to the one or more tools is managed using one or more authentication keys that are inaccessible to the second artificial intelligence agent.

7. The computer-implemented method of claim 1, wherein the applying one or more deterministic operations to derive one or more values for the project is also based at least in part on a natural language input received from a user; and wherein the method further comprises analyzing the natural language input by an artificial intelligence agent to determine at least one other field of the first set of one or more fields.

8. A computer-program product comprising one or more non-transitory machine-readable storage media, including stored instructions configured to cause a computing system to perform a set of actions including:
processing a first input configuring data stored in association with a plurality of fields, wherein the configured data indicates a first set of one or more fields of the plurality of fields is in use and a second set of one or more fields is not in use;
generating a narrative for a project at least in part by:
applying one or more deterministic operations to derive one or more values for the project based at least in part on at least one field of the first set of one or more fields;
based at least in part on the configured data, generating a prompt comprising:
at least the one or more derived values while excluding one or more other values for the second set of one or more fields or one or more other values derived from the second set of one or more fields, and
a context comprising the project for which a narrative is being generated, wherein the project is one of a plurality of projects for which prompts can be generated;
prompting a large language model with the prompt to generate a result; and
storing the result as the narrative for the project; and
causing display of the narrative in a report for the project.

9. The computer-program product of claim 8, wherein the set of actions further includes:
determining one or more narratives based at least in part on the at least one field of the first set of one or more fields; and
editing the one or more narratives to include the one or more derived values; and wherein the prompt also comprises the one or more narratives.

10. The computer-program product of claim 8, wherein the applying one or more deterministic operations further includes:
determining the one or more values to be beyond a threshold value; and
selecting additional information for inclusion in the prompt based at least in part on the one or more values being beyond the threshold value.

11. The computer-program product of claim 8, wherein the prompt specifies a role to assume when answering the prompt, wherein generating the prompt comprises identifying the role based on a u ser account for which the narrative is being generated.

12. The computer-program product of claim 8, wherein the prompt specifies a program name and a program definition for a program being summarized by an answer to the prompt, and wherein generating the prompt comprises identifying the program name and the program definition based at least in part on data stored in association with the program, and inserting the program name and the program definition into the prompt.

13. The computer-program product of claim 8, wherein the applying one or more deterministic operations is performed by a first artificial intelligence agent, wherein the generating a prompt is performed by a second artificial intelligence agent, wherein the first artificial intelligence agent has access to one or more tools using one or more APIs, and wherein access to the one or more tools is managed using one or more authentication keys that are inaccessible to the second artificial intelligence agent.

14. The computer-program product of claim 8, wherein the applying one or more deterministic operations to derive one or more values for the project is also based at least in part on a natural language input received from a user; and wherein the set of actions further includes analyzing the natural language input by an artificial intelligence agent to determine at least one other field of the first set of one or more fields.

15. A system comprising:
one or more processors;
one or more non-transitory computer-readable media storing instructions, which, when executed by the system, cause the system to perform a set of actions including:
processing a first input configuring data stored in association with a plurality of fields, wherein the configured data indicates a first set of one or more fields of the plurality of fields is in use and a second set of one or more fields is not in use;
generating a narrative for a project at least in part by:
applying one or more deterministic operations to derive one or more values for the project based at least in part on at least one field of the first set of one or more fields;
based at least in part on the configured data, generating a prompt comprising:
at least the one or more derived values while excluding one or more other values for the second set of one or more fields or one or more other values derived from the second set of one or more fields, and
a context comprising the project for which a narrative is being generated, wherein the project is one of a plurality of projects for which prompts can be generated;
prompting a large language model with the prompt to generate a result; and
storing the result as the narrative for the project; and
causing display of the narrative in a report for the project.

16. The system of claim 15, wherein the set of actions further includes:
determining one or more narratives based at least in part on the at least one field of the first set of one or more fields; and
editing the one or more narratives to include the one or more derived values; and wherein the prompt also comprises the one or more narratives.

17. The system of claim 15, wherein the applying one or more deterministic operations further includes:
determining the one or more values to be beyond a threshold value; and
selecting additional information for inclusion in the prompt based at least in part on the one or more values being beyond the threshold value.

18. The system of claim 15, wherein the prompt specifies a role to assume when answering the prompt, wherein generating the prompt comprises identifying the role based on a u ser account for which the narrative is being generated.

19. The system of claim 15, wherein the prompt specifies a program name and a program definition for a program being summarized by an answer to the prompt, and wherein generating the prompt comprises identifying the program name and the program definition based at least in part on data stored in association with the program, and inserting the program name and the program definition into the prompt.

20. The system of claim 15, wherein the applying one or more deterministic operations to derive one or more values for the project is also based at least in part on a natural language input received from a user; and wherein the set of actions further includes analyzing the natural language input by an artificial intelligence agent to determine at least one other field of the first set of one or more fields.
